(19) United States
(12) Patent Application Publication
(10) Pub. No.: US 2016/0079780 A1
(43) Pub. Date: Mar. 17, 2016

(54) Portable Recharging Station With Shaded Seating and Method

(71) Applicant: David Lasher, Vista, CA (US)

(72) Inventor: David Lasher, Vista, CA (US)

(21) Appl. No.: 14/855,324

(22) Filed: Sep. 15, 2015

Related U.S. Application Data
(60) Provisional application No. 62/050,645, filed on Sep. 15, 2014.

(51) Int. Cl. H02J 7/00; H02J 7/35

(52) U.S. Cl. CPC H02J 7/0027; H02J 7/355

(57) ABSTRACT

A solar powered charging station device is provided which is configured for recharging mobile devices using battery power such as cell phones, tablets, laptops and other electronic devices. A housing of the device is formed of an upper section having an angled roof with solar panels therein engaged to a lower section having storage batteries and electronic interface equipment. Users may engage charging cords for devices to a charging connector configured for such engagement to the device for charging. A bench provides seating which is shaded by the roof and protected from rain during use.

### FIELD OF THE INVENTION

This application claims priority to U.S. Provisional Patent Application Ser. No. 62/050,645 filed on Sep. 15, 2014, which is included herein in its entirety by this reference thereto.

This invention relates generally to a solar powered charging station configured for recharging cell phones, tablets, laptops and other electronic devices. More particularly, it pertains to an environmentally friendly device and method for the provision of a charging station for electronic devices providing comfortable shaded seating from an overhead shade structure adapted with an angle to increase shade and maximize the output of rooftop solar energized panels producing electrical current to power the device.

### BACKGROUND

In recent years, the popularity of portable electronic devices employed for computing, communications, presentations, mapping and navigation and for other functions has expanded exponentially. In recent years, with the expansion of wireless network capabilities of both public and private networks, smartphones, pad computers, and a plethora of other devices populate the electronics market. All of which have rechargeable batteries which must frequently be charged.

This need to maintain an operable charge on such portable electronic devices will only increase with the ever expanding number of wireless devices and available wireless networks and mobile hotspots to service such devices. By nature, such devices employ electrical power for the broadcast and receipt of data during network connections. Concurrently, with the battery drain caused by RF wireless communications, the display screen and the electronic computing components of the devices all use electrical power to produce the displayed indicia on the engaged display screen and to process the data using software on the computer component of such devices. This results in a continuous plurality of sources of power drain from the batteries on portable wireless devices as well as portable devices which may be hard-wired to a network connection since the onboard network card employs electric power to transmit and receive data over the network.

Other larger devices use onboard electrical power stored in batteries. Such include for example golf carts, wheel chairs, powered coolers for food and other contents, and a host of portable devices which use electricity to function and draw such from batteries. Just as with smaller devices, these large devices using power must be recharged to continue to function.

Conventionally, users of portable electronic devices, both small and large, must plug electric chargers into their electronic portable devices. These charging devices generally are connected to the local electric grid and after a duration of connection will provide a recharge of electric power to onboard batteries of small and large portable devices. Alternatively, many users have vehicle-engageable chargers which may be employed to charge their portable device using a connection to the vehicle in which they may be riding such as a car, truck, airplane, or train or the like, which has an electric generating capability.

However, many public places where users of portable electronic devices may traverse, such as airports, beaches, recreation areas and the like, have severely limited connections to the power grid for recharging portable electronic devices. This lack of grid power results in users of small and larger portable battery-powered electronic devices being unable to recharge their power supplies when such is invariably required.

Additionally, many airlines and train lines do not provide connections for device chargers during travel, or offer connections which are not compatible with the charger employed by many users. Thus, the electronic portable devices of users can frequently discharge onboard batteries to the point the portable device becomes inoperable.

The problem for electronic device users having trouble charging their battery-powered electronic devices is not limited to traveling. Average users frequently forget to charge their device at home or the office, and then find themselves located with their electronic phone or pad computer or other battery-powered device is in danger of losing function when they are visiting a shopping center, mall, campus, beach, outdoor venue such as a zoo or concert, or other venues lacking a connection to the local grid or another power supply.

While there are charging stations inside many such venues such as airports and campuses, such charging stations are at best inconvenient. This is because they require the user to stand proximate to their slowly charging device, or leave it to charge and risk the potential their device might not be at the charging station when they return. Some such charging stations will provide an exchange of a portable charging component engageable with the user's device. However, most such charging stations generally charge very high rates to use the provided power connections, and use grid-power produced by fossil fuels and therefor not environmentally friendly, and not positionable in locations where such grid power is not easily connected.

As such, there is an unmet need for a device and method which will provide for the charging of electronic devices for users who may be situated at airports and train stations, outdoor concert venues, shopping centers, campuses, hotels, spas, parks and other public places not proximate to an electrical grid power connection. Such a device should be adapted to both capture and employ electrical power from a regenerative source which is environmentally friendly. Further, such a device and method should not only provide the users with electrical power, but also provide users a comfortable and preferably shaded and climate controlled area to sit while their device is being re-energized, which also takes advantage of regenerative power sources. Finally, such a device should be configured with electrical storage capacity and sufficient solar electrical generation to allow the charging station device to be located at any outdoor venue without the need for a connection to a power grid, thereby significantly increasing the number of venues where the charging station device may be placed.

With respect to the above, before explaining at least one preferred embodiment of the device and method for recharging portable electronic devices in detail or in general, it is to be understood that the invention is not limited in its application to the details of employment and to the arrangement of the components or the steps set forth in the following description or illustrated in the drawings. The various apparatus and methods of the herein disclosed invention for capturing solar power and providing both charging and cool shaded areas for sitting is capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other charging devices and methods. It is important, therefore, that the embodiments, objects and claims herein, be regarded as including such equivalent construction and methodology insofar as they do not depart from the spirit and scope of the present invention.

### SUMMARY OF THE INVENTION

The charging station device and method herein solve the shortcomings of the prior art, through the provision of an easily loadable combination including a charging station with user seating which is configured for positioning anywhere an adequate sunlight supply is available to generate electrical power. Thus, the device herein may be situated outside in malls or shopping centers, outdoor concert and other arenas, outdoor areas adjacent airports and train stations, beaches, national parks, and virtually anywhere the sun rises for a sufficient time to charge the onboard batteries using the roof-positioned solar cells.

The roof-mounted photovoltaic solar panel or a solar array of such solar panels, includes sufficient solar cells to generate electric power when contacted with the anticipated sunlight in the geographic area which the device is to be located, to charge one or a plurality of onboard eclectic storage batteries operatively engaged to the solar array. The slanted roof, supported by opposing sidewalls, doubles as a shade structure and rain shield for users of the device who may be seated on an underlying bench or seat which is situated to cover a lower housing atop a battery compartment therein. Operative wiring from the solar array to the underlying eclectic storage batteries within the battery compartment is routed through passages within the roof and the supporting sidewalls and thereby communicate to operative engagement with the batteries located in the battery compartment.

The opposing sidewalls engaged to the base on opposite sides of the seating bench are unequal in length to thereby impart a determined slant to the roof and engaged solar array, when operatively situated over the underlying bench. This angle or slant of the roof may be changed to maximize the communication of sunlight to the solar array when the device is operatively postponed on the ground or support surface at a venue. This determined angle of the roof relative to a level roof may change depending on the latitude in which the device is located for operation. A greater incline or slant may be imparted to the roof of devices located at latitudes closer to the North or South poles to better provide for sunlight contact with the solar panel and such may be accommodated by changing the length of extension above the bench of one or both sidewalls which may be configured for independent replacement to accommodate such a change in angular disposition of the roof.

Wired in operative communication with the batteries are a plurality of charging ports, and/or power sockets such as AC power sockets, and/or inductive charging components, which are operatively engaged with power plates positioned on the sidewalls. Appropriate electric transformers and power invertors if needed and other components well known in the art to convert DC solar panel voltage to the desired AC or DC power and voltage, will be situated between the batteries which are charged by the solar panel, as well as in-between the storage batteries and one or a plurality of user-engageable connectors for charging wires located in the power plates.

One or a plurality of power plates will be populated with such electrical connectors which may vary in mechanical configuration for allowing for engagement for any of multiple power cords which users may employ to communicate electric power from the charging station device, to charge the battery on their respective electronic device, or to power for instance an AC powered device such as a drill or charging of electric vehicles.

Inductive charging connection areas may also be provided for wireless charging. Such will allow users having differing power cord connectors to operatively connect their electronic device to the system herein for charging or to power the device in real time. The connectors are of course adapted for replacement to allow for engagement of new connecters as standards change over time.

Additionally, provided to facilitate easy transport and location is a recess or passage formed at a bottom edge of opposing sidewalls of the lower housing section of the charging station device. A passage communicating between and through the recesses in the bottom edges of the opposing sidewalls will allow for the operative communication of forks from a pallet jack or forklift or the like to elevate the charging station device for easy rolling transport to a desired position at a venue or geographic location.

Further provided in the favored mode of the device, is an LED illuminated overhead panel to provide lighting to the area of the charging station under the roof. Such will run on electrical power generated by the solar panels or array and will use minimal electrical power to provide maximum illumination of the seating area under the roof when required.

Employing the onboard electric power generated by the solar array and stored in the onboard batteries located within the lower housing, and employing electric components operatively engaged for the interfacing electric power to the component or purpose, the device may also be configured for:

security camera monitoring of surrounding areas employing WiFi or other wireless communication to communicate captured images;

providing cooling fans and/or water misting for users positioned under the roof;

providing a potable water supply to users through the employment of solar powered water condensing;

providing an emergency medical station where patients may be provided care remotely;

providing a safe haven wherein operative RF monitoring components and software running on a computing device powered by the power from the device would ascertain any emergency call made within 100 feet and emit a light and sound beacon to dissuade attackers and or alert first responders to the area of the situation;

providing cold water and other products using solar powered refrigeration;

using onboard wireless communications equipment powered by the charging station device, providing weather information from an onboard display and speakers or interactive sports odds/betting;

using an onboard display powered by the batteries of the charging station device to operatively engaged wireless media electronic components to generate a feed to the display and/or sound, provide a news feed, sports scores, interactive news, a stock ticker, a local events calendar, a photo booth, a video calling station, a Lo-jack/find my phone interface, an emergency telephone call station or beacon, or other media which may be generated by the onboard electronic equipment operatively powered by the power generated by the device.

Additionally, employing the onboard power generated by the batteries or solar panels of the charging station device, and operative electronic components also thereby powered, the charging station device may also function as an emergency broadcast system warning device to warn people proximate thereto of an immediate emergency, and to emit a visual and/or audio warning and safety instructions in such an event, for example an approaching tsunami at a beach location.

Finally, the device and system may function using the onboard power as an Amber/Silver Alert notification system to operative electronic phones and computers of people proximate to the charging station device in the event of an Amber Alert or Silver Alert. In such an event, operative well known electronic components operatively engaged with the charging station device would emit a visual and audio signal, as well as provide images on the onboard display of those missing, their last known whereabouts and any vehicle information pertinent to the bulletin.

As can be discerned, the charging station device herein, through the provision of onboard electrical power generation and storage capacity, can provide any or all of the above functions in a single unit, all of which are enabled wirelessly thereby allowing the positioning of the device virtually anywhere sufficient sunlight is available to provide the electrical power from the onboard solar array, to charge onboard electric storage such as a battery or batteries, to power the electronic components needed for the included functions.

It is an object of this invention to provide an electric power generation charging station device in combination with a roofed seating area for users to occupy during use.

Another object of the invention is to provide such a power generation device and user occupied roofed housing which includes power connections and wireless communications to operate a plurality of electronic components and video displays and audio producing components to enable the device for multi functions without the need for a connection to the power grid or a hard wired connection to a network.

The foregoing has outlined some of the more pertinent objects of the invention provided by the device and system herein. These objects should be construed to be merely illustrative of some of the more prominent features and applications of the intended invention. Many other beneficial results can be attained by applying the disclosed device and system in a different manner or by modifying the invention within the scope of the disclosure.

Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

FIG. 1 is perspective view of a preferred mode of the charging station device showing a housing formed of a lower section or bench portion covered by an engaged upper section having an angled roof supported by opposing support walls defining a tilt to the roof.

FIG. 2 depicts a mode of the charging station device of FIG. 1 also showing multiple charging connections which may be differently configured for different plug configurations and an optional area for video display and/or payment interfaces such as credit card readers if necessary, and an optional tilting solar panel axis.

FIG. 3 is a cut-away sectional view of the charging station device of FIG. 1 or 2, showing the engagement of the lower section of the housing of the charging station device to the upper section.

FIG. 4 shows a elevation view of the lower section of the housing having a passage communicating thereunder between opposing sides.

FIG. 5 is a sectional view through the lower section of the housing of FIG. 4 showing the interior compartment within the lower section defining the bench portion and enclosing the battery, electronic interface components.

FIG. 6 depicts another sectional view through the lower section of the housing providing the base for the charging station device and storage compartment.

FIG. 7 shows one mode of a mating surface providing a removable engagement between the support walls of the upper section and the lower section of the housing, and as could also be used on inserts if also employed to raise or lower the angle of the solar panel.

FIG. 8 depicts a depiction of a side view of the upper section of the housing showing the support walls which can be varied in length to change the roof angle by changing their lengths and/or using engageable inserts of differing widths.

FIG. 9 shows a mode of the power plate employed for operative engagement of power chord sockets and engagement components.

FIG. 10 depicts one preferred mode of the layered configuration of the LED lighting and diffusers.

### DETAILED DESCRIPTION OF THE INVENTION

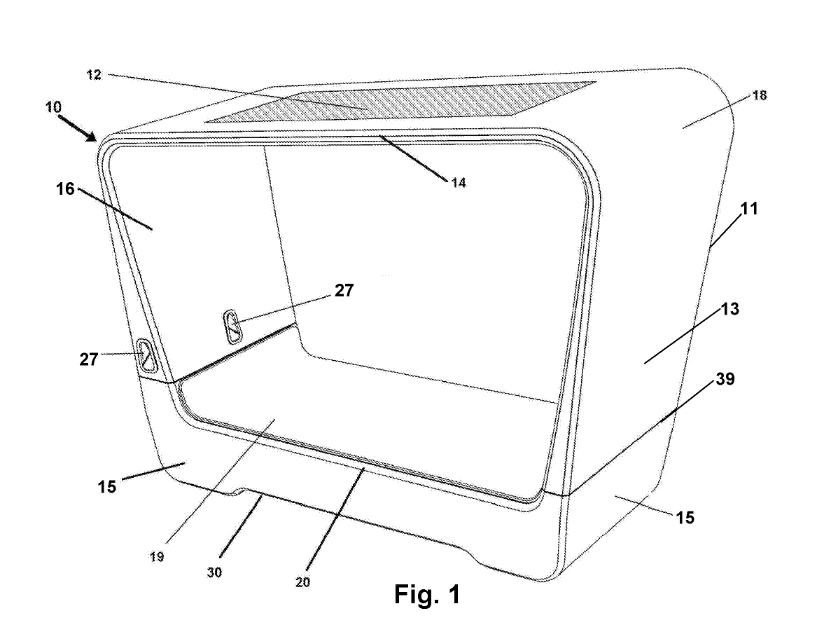

Referring now to FIGS. 1-10 herein, wherein similar components are identified by the same numerals, there can be seen in one favored view of the charging station device 10 showing an assembled view showing the structural and ornamental aspects of the unique configuration of the assembled device 10. The device 10 has a housing 11 formed of an upper section 13 in a removable engagement to a lower section 15 which provides for ease of configuration the tilt of the roof 14 to adjust an angle of the solar panel 12 thereon. The device 10 is lightweight and easily loadable thereby providing a combination charging station and user shelter and seating apparatus which is adapted for positioning anywhere an adequate sunlight supply is available for the solar panel 12.

Shown in FIGS. 1-3 are a roof-mounted photovoltaic solar panel 12 or solar array, which includes sufficient solar cells to generate electric power for the intended use of the device 10 taking into consideration the geographic area which the device 10 is to be located. The roof 14, providing the mount for the solar panel 12, is supported by opposing support walls 16 and 18, and so supported, forms a shade structure within the user cavity between the roof 14 and the bench 20 as well as a rain shield for users who may be seated on the underlying bench 20 positioned on top of a lower section 15 of the housing 11.

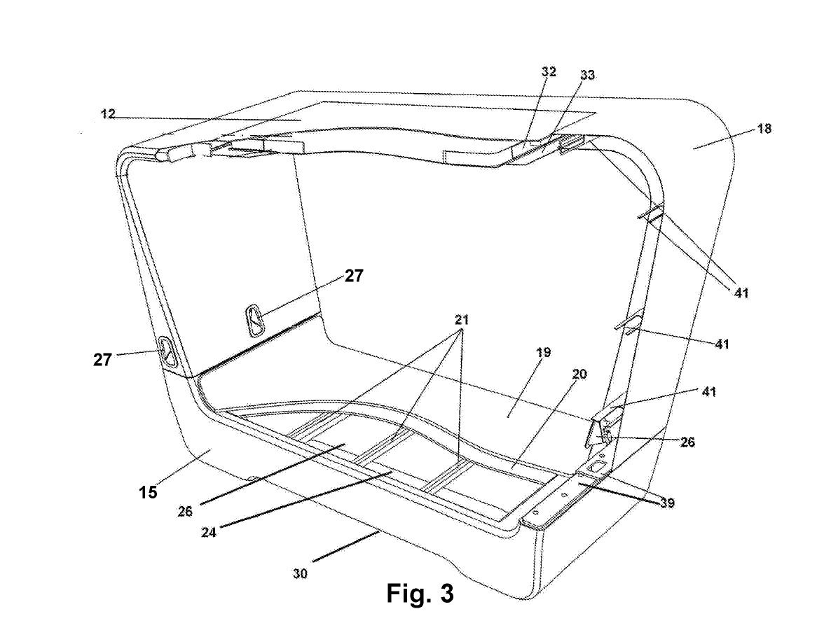

Shown in FIG. 3, the lower section 11 of the housing 11 has an interior cavity 24 underneath the bench 20 which may be padded with a cushion 19. Supports 21 support users seated on the upper wall of the cavity 24 defining the bench 20 and which defines a top area of the interior cavity 24 which is sized for the operative positioning of a plurality of one or a plurality of batteries 26 therein.

Operative wiring (not shown but well known) communicates through both the lower section 15 and upper section 13 of the housing 11 such as running through supports 41 in the support wall 18 along a race therein, from the solar array or solar panel 12. This allows communication of electric power to the underlying batteries 26 within the interior cavity 24. The wiring for both the batteries 26, and any electronic interfaces, wireless communications, inventors, transformers, and to and from video displays and charging connections, and the like, is routed through passages within the roof 14 and the supporting sidewalls 16 and 18 and the interior cavity 24 and is well known in the art and need not complicate the drawings by depiction thereof.

As shown in FIGS. 1-3 the opposing support walls 16 and 18 are engaged to the lower section 15 of the housing 11 on opposite sides of the formed bench 20 using removable mating connections between both components such as plates 39 operatively positioned on both the support walls 16 and 18 and opposite ends of the lower section 13 of the housing 11.

The sidewalls 16 and 18 as shown, are purposely formed unequal in length to thereby impart a determined slant to the roof 14 providing the mount for the solar array 12. This angle of the roof 14 can be changed, by changing the respective length of one or both sidewalls 16 and 18. The angle of the roof 14 being changeable is particularly preferred so as to maximize the communication of sunlight to the solar panel 12 of the device 10, depending on the latitude in which the device 10 is positioned for operation.

Wired in operative communication with the batteries 26 are a one or preferably a plurality of charging ports engaged with the housing 11 with plates or power plates 27. The plates 27 are configured to engage with the housing 11 with one surface exposed which has an electric connector therein such as such as AC or DC power sockets, and/or inductive charging components, which are operatively engaged with power plates 27 positioned on the sidewalls 16 and 18 or roof 12 interior. Such connectors might also include USB cord connectors, plug receptacles for AC power cords, or any other connector configured to engage and existing or future connector used for charging a portable electrically powered device. The plurality of power plates 27 can be populated with a plurality of differing electrical connectors adapted to engage a plurality of different power cords which users may employ to communicate electric power from the device 10, to their respective electrical device for charging, or to power for instance an AC powered device.

Additionally preferred in the device 10, as shown in FIGS. 1-3 for example, to facilitate easy transport, is a recess 30 formed in opposing sidewalls of the lower section 15 of the housing 11. As noted the opposing recesses 30 form a passage therethrough and therebetween, underneath the lower section 15 configured for engagement of a lifting component such as forks from a pallet jack or forklift or similar lifting component which may be employed to elevate the device 10 for easy rolling transport to the desired position.

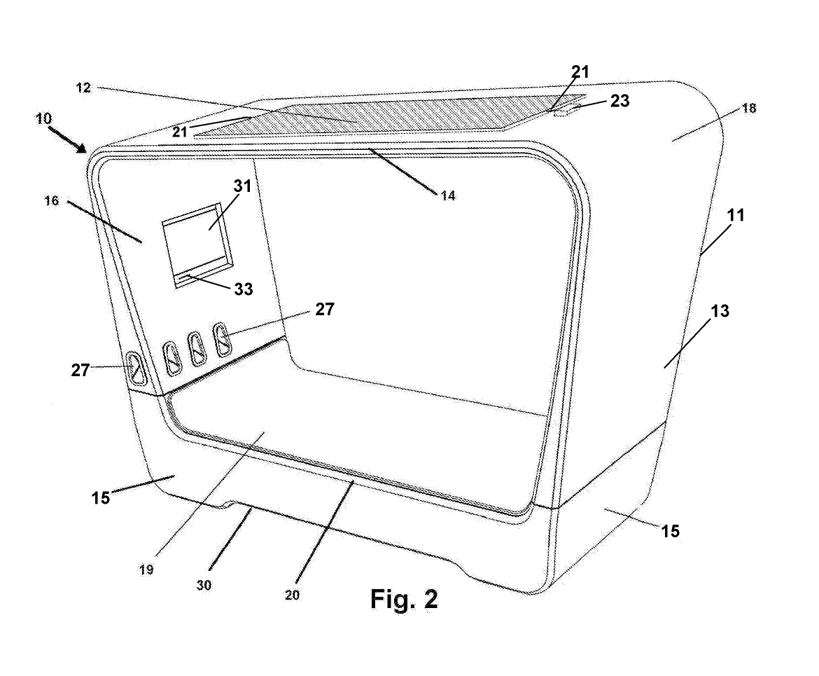

As shown in FIG. 2, the device 10 may also include an engagement of the solar panel 12 to the roof 14 on a rotatable member or axis 21. The axis 21 may be engaged to an electrically operated or mechanical rotating component 23 such as an electric motor. With the included axis 21 engagement of the solar panel 12, it may be tilted around the axis 21 to optimize the angle of contact of sunlight with the solar panel 12, in addition to adjusting the tilt of the roof 14. By including the axis 21 and rotating component 23 the solar panel 12 will thus be angularly adjustable in two different planes. Additionally, shown in FIG. 2 are an optional video display 31 and the inclusions of means for electronic payment by a user such as a credit card reader 33 or other means for digitally authorizing payment.

Shown in FIG. 3, and additionally preferred for inclusion in the favored mode of the device 10 herein, is an LED illuminated panel 32. The illuminated panel 32 is preferred to provide illumination to the area under the roof 12 which is a low power draw from generated power from the solar panel 12. A diffuser 33 is situated to provide even directed light from the LED panel 32.

As noted, using the electric power generated by the solar panel 12 and stored in a plurality of batteries 26 within the lower section 15 of the housing 11, and employing electric components operatively engaged for the purpose, the device may also be configured with a digital video camera for security camera monitoring of surrounding areas. The camera may employ hard wiring or wireless communication to send captured images to a remote location. A fan may be engaged to the roof 14 of support walls 16 and 18, to provide a cooling breeze to users positioned under the roof 14.

In other modes a water filtering component might be powered and engaged and provide a potable water supply to users or such might be supplied using solar powered water condensing. Using RF communication equipment 41 such as transceivers the device 10 may be configured for RF monitoring and software running on a computing device 43 having electronic memory and electronic computing processors powered by the power from the device 10 can operate as a cellular antenna and re broadcaster and also operate to monitor RF traffic and ascertain any emergency call made within 100 feet of the device 10. Thereafter, it may be configured to emit a discernable alarm, such as a light and sound beacon to dissuade attackers and or alert first responders to the area of the situation.

Additionally, the computing device 43 and the onboard wireless RF communications equipment 41 powered by the device 10 and the video display 31 the device 10 can be enabled to provide weather information from the onboard display 41 and speakers (not shown). Or the device 10 can be configured as an informational stand using an onboard display 31 powered by the device and operatively engaged electronic components of the computing device 43 to generate a video display feed to the display 31 and/or sound, and thereby provide users with a news feed, sports scores, interactive news, a stock ticker, a local events calendar, a photo booth, a video calling station, a Lo-jack/find my phone interface, an emergency telephone call station or beacon, or other media which may be generated by the onboard electronic equipment operatively powered by the power generated by the device.

Additionally, employing the onboard power generated by the device 10, and operative electronic components of the computing device 43 powered by the device 10, the device may also function as an emergency broadcast system warning device to warn people proximate thereto of an immediate emergency, and emit the alarm as a visual and/or audio warning and safety instructions in such an event. Further, the device 10 using the onboard power may be configured to function as an Amber/Silver Alert notification system for people proximate to the device 10 in the event of an Amber Alert or Silver Alert communicated wirelessly to the device.

As can be discerned, the device 10, through the provision of onboard electrical power generation and storage capacity, can be easily configured by those skilled in the art, with wiring and computing devices 43 and RF wireless communications 41 and display screen 31 and audio, to provide any or all of the above functions in a single unit. Consequently, such components need not be shown in detail.

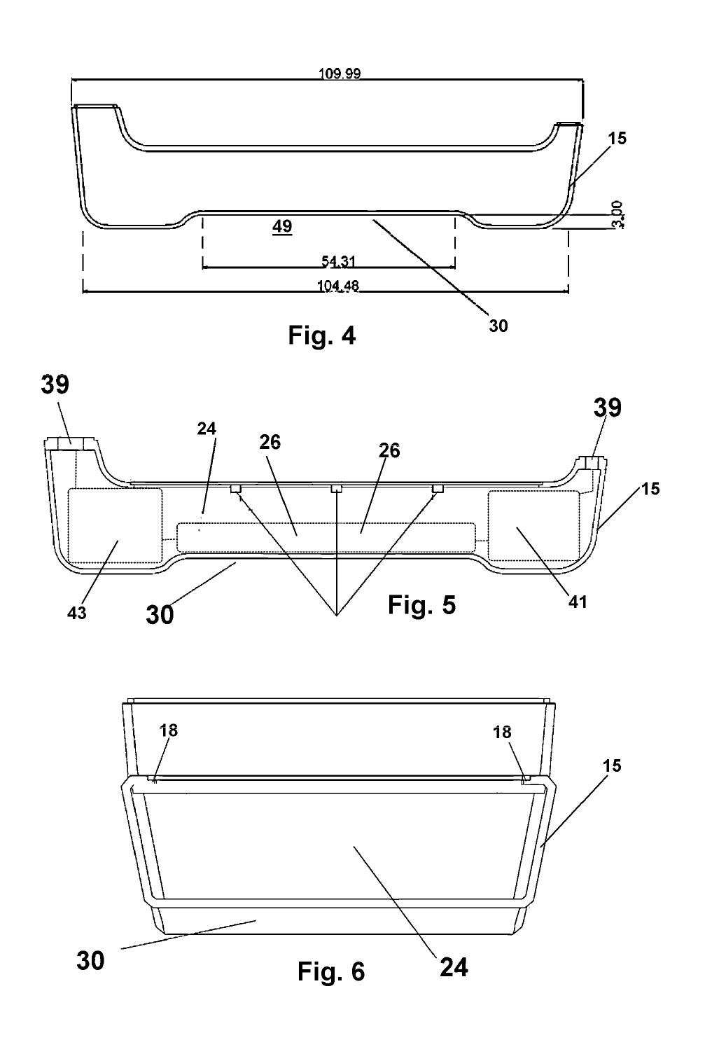

Seen in FIGS. 4-6 are differing views of the lower section 15 which is removably engageable to the upper section 13 forming the housing 11 of the device 10. Currently preferred dimensions of the device 10 lower section 15 are shown in FIG. 4, including the three inch wide passage 49 communicating underneath the lower section 15.

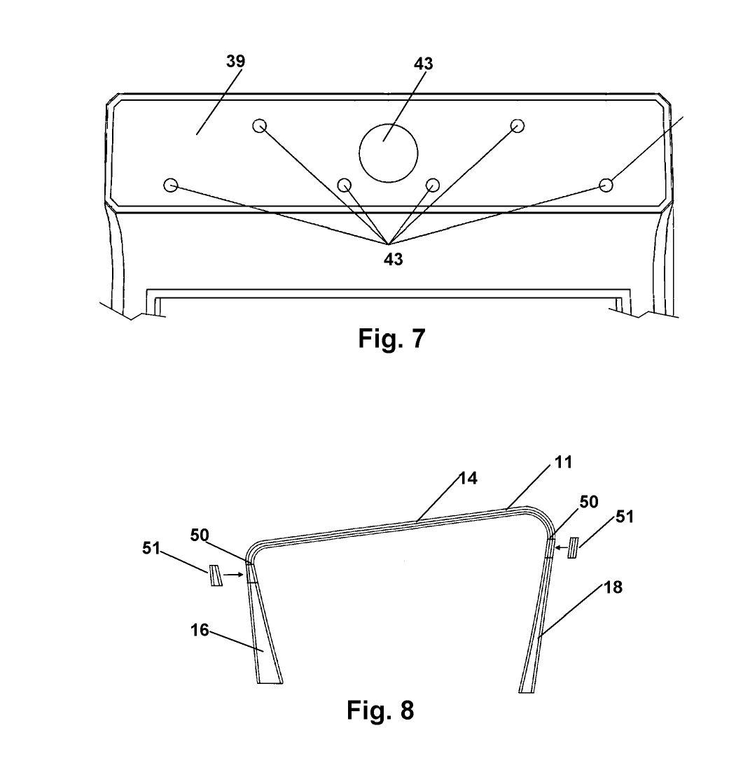

Also shown in FIGS. 4-6 and in FIG. 7, are the removably engageable mating connections for the lower section 15 of the housing 11 to the support walls 16 and 18 of the upper portion 13 of the housing 11. The plates 39 on both the support walls 16 and 18 and the lower section 15 of the housing 11, have apertures 43 which are aligned when the plates 39 are mated. Thereafter, removable connectors such as a nuts and bolts can be engaged through the aligned mated apertures 43. A wiring aperture 43 is also shown for passage of operative wiring engagements therethrough.

In FIG. 8 is shown a side view of an upper portion 13 of the housing 11 which can be engaged to any lower portion 15 having the mating connections therefor. As shown the opposing support walls 16 and 18, can be configured with a gap 50 for insertion of wall inserts 51 in-between the roof 14 and the support walls 16 and 18. The wall inserts 51 would engage with mating connections as noted above or other mating connections such as a sliding engagement of each wall insert 51 in between a support wall 16 or 18, and the roof 14. Such can be by a slots formed in the mating surfaces of both the roof 14 and the top of each support wall 16 and 18 engageable by projections on each side surface of the wall insert 51, or other means of engagement therebetween known in the art.

Consequently, the angle of the roof 14 and attached solar panel 12 is abusable relative to a level surface such as the depicted bench 20. The angle of the roof 14 may be adjusted by changing the length of either of the support walls 16 and 18 to thereby change the angle of the roof 14 when the upper section 13 is engaged to the lower section 15 of the housing 11. Or inserts 51 of differing widths can be engaged into the formed gap 50 in the support walls 16 and 18. The gaps 50 themselves may be two engaged surfaces of a support wall 16 and 18 and the roof 14, which are disengageable for removable engagement of an insert 51 therein using the same connection between mating surfaces as the roof 14 and the sidewalls 18.

The device 10 being portable and solar powered is adapted for positioning anywhere sufficient sunlight is available, and as such may be provided to users as an accommodation by venue owners such as shopping centers, or can be positioned as part of plurality of available charging and communication stations available to subscribing members who would log in upon starting use of a device 10 at a location and have an account which is paid by the subscriber for access to the devices 10 in the plurality of locations available.

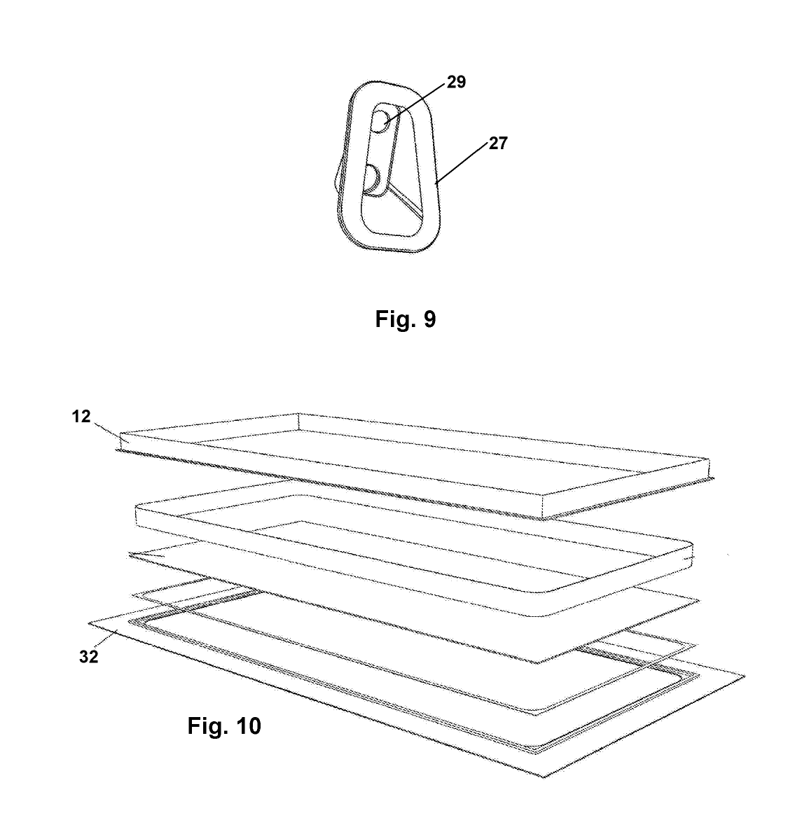

FIG. 9 is a depiction of one mode of the power plates 27 which may be employed herein. Also shown are the one or a plurality of openings 29 which can be fitted with differing electrical connections for differing charging cords.

Shown in FIG. 10 is the layered configuration for the light for the device to illuminate the user cavity between the roof 14 and bench 20.

While all of the fundamental characteristics and features of the disclosed power generating portable structure have been shown and described, a latitude of modification, various changes and substitutions are intended in the foregoing disclosure. It will be apparent that in some instance, some features of the invention may be employed without a corresponding use of other features, or steps may be rearranged for operations, without departing from the scope of the invention as set forth. It should be understood that any such substitutions, modifications, and variations, may be made by those skilled in the art, without departing from the spirit or scope of the invention. Consequently, all such modifications and variations are included within the scope of the invention as defined herein.

What is claimed is:

1. The portable recharging station for charging battery powered devices, comprising:
a housing having an upper section removably engageable with a lower section;
said upper section having a roof having an upper surface and a lower surface, said roof engaged at a first end with a first end of a first support wall and at a second end with a first end of a second support wall;
said first support wall having a second end in an engagement at or adjacent a first end of said lower section;
said second support wall having a second end in an engagement at or adjacent a second end of said lower section;
a first of said support walls having a first length extending between said roof and said lower section, said first length being shorter than a second length of said second support wall extending between said roof and said lower section;
said roof inclining in an angle running from said first end toward said second end thereof;
a solar panel operatively positioned with said upper surface of said roof;
a user occupiable area in-between said first support wall, said second support wall, said roof, and said lower section of said housing;
a charging connection in electrical communication with electricity produced by said solar panel, said charging connection engaged with said housing, whereby a user can plug a charging cord into said charging connection to communicate said electricity to recharge a battery.

2. The portable recharging station of claim 1, additionally comprising:
said lower section of said housing having opposing sidewalls communicating between said first end and said second end of said lower section;
said sidewalls each having distal ends for supporting said portable recharging station on a support surface;
a cavity formed between said opposing sidewalls and said first end of said lower section and said second end of said lower section;
a recess formed into said distal ends at a central area of each of said sidewalls, thereby defining a pair of opposing recesses; and
a passage communicating between said pair of opposing recesses, said passage sized for communication of a lifting member therethrough, whereby said recharging station can be elevated by said lifting component for an elevated transport to a location.

3. The portable recharging station of claim 1, additionally comprising:
said roof and said first support wall and said second support wall forming said upper section as a unitary structure;
said inclining angle of said roof being adjustable by engaging a secondary upper section to said lower section of said housing, where said first support wall or a said second support wall of said secondary upper section have a different respective said first length or said second length.

4. The portable recharging station of claim 2, additionally comprising:
said roof and said first support wall and said second support wall forming said upper section as a unitary structure;
said inclining angle of said roof being adjustable by engaging a secondary upper section to said lower section of said housing, where said first support wall or a said second support wall of said secondary upper section have a different respective said first length or said second length.

5. The portable recharging station of claim 1, additionally comprising:
gaps formable in said first support wall or said second support wall in-between said roof and said second section of said housing;
wall inserts engageable in said gaps;
an insert width of each said wall insert being a portion of said first width of said first support wall or said second width of said second support wall; and
said inclining angle of said roof being adjustable by engaging said wall inserts having differing said insert widths within one or both of said gaps.

6. The portable recharging station of claim 2, additionally comprising:
gaps formable in said first support wall or said second support wall in-between said roof and said second section of said housing;
wall inserts engageable in said gaps;
an insert width of each said wall insert being a portion of said first width of said first support wall or said second width of said second support wall; and
said inclining angle of said roof being adjustable by engaging said wall inserts having differing said insert widths within one or both of said gaps.

7. The portable recharging station of claim 3, additionally comprising:
gaps formable in said first support wall or said second support wall in-between said roof and said second section of said housing;
wall inserts engageable in said gaps;
an insert width of each said wall insert being a portion of said first width of said first support wall or said second width of said second support wall; and
said inclining angle of said roof being adjustable by engaging said wall inserts having differing said insert widths within one or both of said gaps.

8. The portable recharging station of claim 4, additionally comprising:
gaps formable in said first support wall or said second support wall in-between said roof and said second section of said housing;
wall inserts engageable in said gaps;
an insert width of each said wall insert being a portion of said first width of said first support wall or said second width of said second support wall; and
said inclining angle of said roof being adjustable by engaging said wall inserts having differing said insert widths within one or both of said gaps.

9. The portable recharging station of claim 1, additionally comprising:
a light emitting fixture positioned on said bottom surface of said roof; and
said light emitting fixture communicating illumination therefrom to said user occupiable area.

10. The portable recharging station of claim 2, additionally comprising:
a light emitting fixture positioned on said bottom surface of said roof; and
said light emitting fixture communicating illumination therefrom to said user occupiable area.

11. The portable recharging station of claim 3, additionally comprising:
a light emitting fixture positioned on said bottom surface of said roof; and
said light emitting fixture communicating illumination therefrom to said user occupiable area.

12. The portable recharging station of claim 4, additionally comprising:
a light emitting fixture positioned on said bottom surface of said roof; and
said light emitting fixture communicating illumination therefrom to said user occupiable area.

13. The portable recharging station of claim 5, additionally comprising:
a light emitting fixture positioned on said bottom surface of said roof; and
said light emitting fixture communicating illumination therefrom to said user occupiable area.

14. The portable recharging station of claim 6, additionally comprising:
a light emitting fixture positioned on said bottom surface of said roof; and
said light emitting fixture communicating illumination therefrom to said user occupiable area.
